(19) United States
(12) Patent Application Publication
(10) Pub. No.: US 2009/0164137 A1
(43) Pub. Date: Jun. 25, 2009

(54) MULTIFUNCTIONAL PORTABLE ELECTRONIC DEVICE

(75) Inventor: Tung-Lung Lee, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/164,245

(22) Filed: Jun. 30, 2008

(30) Foreign Application Priority Data
Dec. 21, 2007 (CN) 200710203342.3

(51) Int. Cl. G01N 31/00

(52) U.S. Cl. 702/23

(57) ABSTRACT

A multifunctional portable electronic device (100) that easily allows a user to test dangerous fumes level is described. A power module (10) supplies a working voltage to a gas-sensing module (12) and an output voltage of the gas-sensing module is generated after sensing gas. A signal processor converts the output voltage of the gas-sensing module into a digital signal and calculates a corresponding gas concentration value that can be displayed on a display module (18).

### CROSS-REFERENCE TO RELATED APPLICATION

This application is related to a co-pending U.S. patent application (Attorney Docket No. [US15142]), entitled “MULTIFUNCTIONAL PORTABLE ELECTRONIC DEVICE”, by Tung-Lung Lee. Such application has the same assignee as the present application and is concurrently filed herewith. The disclosure of the above-identified application is incorporated herein by reference.

### BACKGROUND OF THE INVENTION

1. Field of the Invention

The present invention generally relates to portable electronic devices, and more particularly to a multifunctional electronic device.

2. Description of Related Art

In our daily life, we may often be exposed to toxic fumes such as automobile exhaust or even flammable fumes.

Although sensing devices are available for alerting to the presence of dangerous fumes they are not commonly used by people in their daily lives, like mobile phones are. And if people were concerned enough to carry a protective sensor it would be inconvenient.

Therefore, a new multifunctional portable electronic device having a function of sensing dangerous fumes is desirable to overcome the above-described problems.

### BRIEF DESCRIPTION OF THE DRAWINGS

Many aspects of the multifunctional portable electronic device can be better understood with reference to the following drawings. Drawings are not necessarily drawn to scale, the emphasis instead being placed upon clearly illustrating the principles of the present multifunctional portable electronic device. Moreover, in the drawings, like reference numerals designate corresponding parts throughout the several views, in which:

FIG. 1 is a block diagram of a multifunctional portable electronic device according to an examplary embodiment of the invention;

FIG. 2 is a first embodiment of a circuit diagram of a gas-sensing module of the multifunctional portable electronic device shown in FIG. 1;

FIG. 3 is a second embodiment of a circuit diagram of a gas-sensing module of the multifunctional portable electronic device shown in FIG. 1; and

FIG. 4 is an isometric view of the multifunctional portable electronic device shown in FIG. 1.

### DETAILED DESCRIPTION OF THE EMBODIMENTS

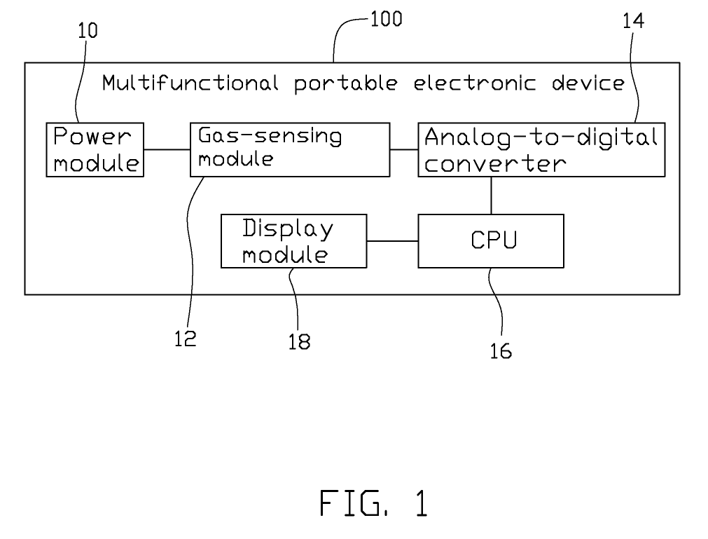

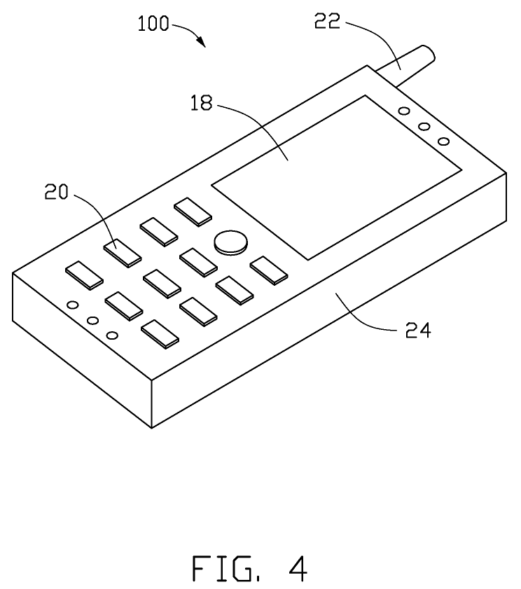

Referring to FIGS. 1 and 4, an exemplary embodiment of a multifunctional portable electronic device 100 in the form of a mobile phone is shown. The multifunctional portable electronic device 100 includes a power module 10, supplying power for a gas-sensing module 12, an analog-to-digital converter 14, a central processing unit (CPU) 16, a display module 18, a keypad 20, an antenna 22 and a integrated telephone module 24. The keypad 20 allows inputting information. The antenna 22 receives and transmits signals from/to a telephone module 24.

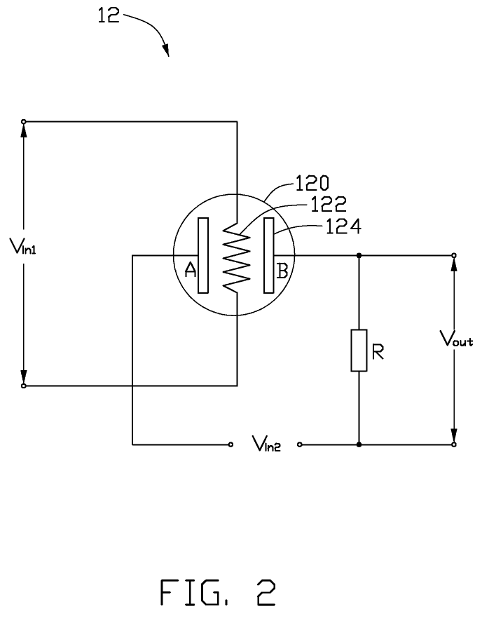

Referring to FIG. 2, in the first embodiment of present invention, the gas-sensing module 12 includes a gas-sensing portion 120 and a dividing resistor R. The gas-sensing portion 120 includes a heater 122 and a detector (124, A, B). The heater 122 is an inductance, and when in use, the heater 122 radiates heat to achieve a temperature condition suitable for allowing gas sensing. The detector is a pair of electrodes 124 comprising a first electrode A and a second electrode B, and the heater 122 is positioned therebetween. The electrodes 124 have a conventional gas-sensitive material thereon for sensing gases, such as carbon dioxide (CO2), methyl hydride, chlorine, sulfide, oil-gas, and so on.

The power module 10 supplies a first input voltage Vᵢₙ₁ and a second input voltage Vᵢₙ₂. The Vᵢₙ₁ is input on the heater 122 to form a loop as a heating circuit of the gas-sensing module 12. The first input voltage Vᵢₙ₁ is a working voltage of the heating circuit.

The electrodes 124 and the resistor R are electronically connected in series. The second input voltage Vᵢₙ₂ is input to the electrodes 124 and the resistor R to form a loop as a signal output circuit of the gas-sensing module 12. The voltage at the resistor R is an output voltage Vₒᵤₜ of the gas-sensing module 12. The second input voltage Vᵢₙ₂ is a working voltage for the signal output circuit. In general, the working voltage of the signal output circuit is about 5V.

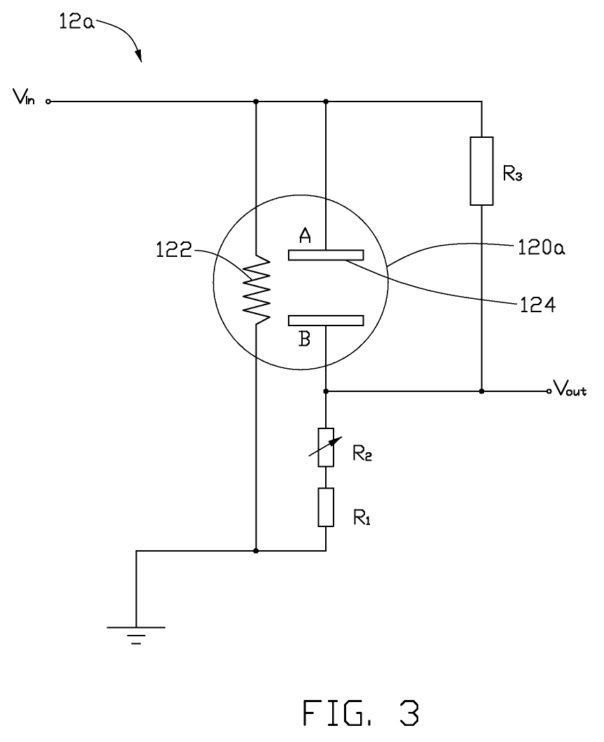

Referring to FIG. 3, in the second exemplary embodiment of present invention, the gas-sensing module 12a includes a gas-sensing portion 120a, a first resistor R₁, a second resistor R₂ and a third resistor R₃. The gas-sensing portion 120a includes a heater 122 and a pair of electrodes 124 comprising a first electrode A and a second electrode B. The heater 122 is an inductor provided between the first electrode A and the second electrode B. When in use, the heater 122 radiates heat to achieve a temperature condition suitable for gas sensing. At least one of the first resistor R₁ and the second resistor R₂ is an adjustable resistor.

The electrodes 124 and the third resistor R₃ are connected in parallel, and then connected in series to the first resistor R₁ and the second resistor R₂, and then all the resistors are connected in parallel to the heater 122. One end of the heater 122 is grounded, and the other end is connected to an input voltage Vᵢₙ. A voltage at the first resistor R₁ and the second resistor R₂ is an output voltage Vₒᵤₜ of the gas-sensing module 12.

The heater 122 provided with an input voltage Vᵢₙ is used as a heating circuit of the gas-sensing module 12. The electrodes 124 and the third resistor R₃, provided with the input voltage Vᵢₙ, are used as a signal output circuit of the gas-sensing module 12. The first resistor R₁ and the second resistor R₂ are used as a voltage divider for adjusting the working voltage of the signal output circuit. The third resistor R₃ is a shunt resistor provided for optimizing the linear characteristics of the signal output circuit.

Referring to FIGS. 1 and 2, or referring to FIGS. 1 and 3, the power module 10 supplies a working voltage for the heating circuit and the signal output circuit of the gas-sensing module 12, 12a. When the working voltage is input, the heater 122 radiates heat to achieve a temperature condition of the electrodes 124 suitable for sensing gas. When a detectable gas is present in the air around the device 100, it is adsorbed on a surface of the electrodes 124, and the surface resistance Rₛ of the electrodes 124 changes accordingly. That is, the electrodes 124 have different resistance Rₛ corresponding to different sensed gas concentration values. The output voltage Vₒᵤₜ of the gas-sensing module 12, 12a will then varies with the change of the surface resistance Rₛ of the electrodes 124. The analog-to-digital converter 14 converts the analog signal of the output voltage Vₒᵤₜ into a digital signal usable by the CPU 16.

The CPU 16 calculates a corresponding gas concentration value based on the received digital signal, and sends the gas concentration value to the display module 18. The display module 18 includes a display screen of the multifunctional portable electronic device 100. The sensed gas concentration value is displayed in the display module 18.

It should understood that, the multifunctional portable electronic device can be a mobile phone, a personal digital assistant (PDA), and so on. The analog-digital converter 14 and the CPU 16 can be replaced by a signal processor with analog-to-digital converting function and data processing function, such as a single chip, a integrate circuit, and so on.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A multifunctional portable electronic device comprising:
a power module;
a gas-sensing module electronically connected to the power module, the power module supplying a working voltage to the gas-sensing module, and the gas-sensing module generating an output voltage after sensing gas;
a signal processor electronically connected to the gas-sensing module, the signal processor converting the output voltage of the gas-sensing module into a digital signal used for calculating a corresponding gas concentration value; and
a display module electronically connected to the gas-sensing module for displaying the gas concentration value received from the signal processor.

2. The multifunctional portable electronic device of claim 1, wherein the signal processor includes an analog-to-digital converter and a CPU electronically connected to each other, the analog-to-digital converter is connected to the gas-sensing module, and the CPU is connected to the display module.

3. The multifunctional portable electronic device of claim 2, wherein the gas-sensing module includes a heating circuit for radiating heat to achieve a temperature condition suitable for gas sensing, and a signal output circuit for sensing gas concentration and outputting a voltage to the analog-to-digital converter.

4. The multifunctional portable electronic device of claim 3, wherein the heating circuit includes a heater electronically connected to the power module.

5. The multifunctional portable electronic device of claim 4, wherein the signal output circuit includes a detector and at least one resistor, the detector and the at least one divider resistor being connected in series, and the voltage across the at least one divider resistor comprising the output voltage of the gas-sensing module.

6. The multifunctional portable electronic device of claim 5, wherein the sensing member is a pair of electrodes including a first electrode and a second electrode, the heater being configured between the first electrode and the second electrode.

7. The multifunctional portable electronic device of claim 4, wherein the heater further comprises an inductance heater.

8. The multifunctional portable electronic device of claim 5, wherein the signal output circuit further includes a shunt resistor electronically connected to the detector.

9. The multifunctional portable electronic device of claim 8, wherein the heater further comprises an inductance heater.

10. The multifunctional portable electronic device of claim 6, wherein the analog-to-digital converter converts the output voltage of the gas-sensing module into a digital signal usable by the CPU, and the CPU calculating a corresponding gas concentration value based on the digital signal received from the analog-to-digital converter, and the CPU sends the gas concentration value to the display module.

11. The multifunctional portable electronic device of claim 1, further comprising an integrated telephone module.
